(19) United States
(12) Patent Application Publication
(10) Pub. No.: US 2021/0247013 A1
(43) Pub. Date: Aug. 12, 2021

(54) Tamper-Resistant Locking Device And Method

(71) Applicant: Uniweld Products, Inc., Fort Lauderdale, FL (US)

(72) Inventors: Dragan Bukur, Fort Lauderdale, FL (US); David S. Pearl, II, Fort Lauderdale, FL (US); David Foster, Tamarac, FL (US); Douglas B. Pearl, Hollywood, FL (US)

(21) Appl. No.: 17/146,939

(22) Filed: Jan. 12, 2021

Related U.S. Application Data
(60) Provisional application No. 62/975,263, filed on Feb. 12, 2020.

(51) Int. Cl. F16L 55/115; F25D 23/02

(52) U.S. Cl. CPC F16L 55/1152; F25D 23/028

(57) ABSTRACT

Locking device and seal for an access fitting/valve, and methods of locking an access fitting/valve. The locking device may comprise an outer housing having a first internal cavity and an upper surface having an aperture; an inner housing configured to be received in the internal cavity of the outer housing, the inner housing having a second internal cavity defined by side walls at least a portion of which having internal threads for threadably connecting to an access fitting having corresponding external threads, the inner housing further having a recess having a keyed shape configured to be received by a corresponding tool or key. The inner housing is independently rotatable inside the outer housing about a common or coaxial longitudinal axis, and thus is spaced from the inner side wails of the outer housing when in the assembled condition.

This application claims priority of U.S. Provisional Application Ser. No. 62/975,263 filed Feb. 12, 2020, the disclosure of which is incorporated herein by reference in its entirety.

### BACKGROUND OF THE INVENTION

Embodiments disclosed herein generally relate to tamper-resistant locking devices particularly useful for preventing unauthorized access to refrigerant gases present in refrigeration apparatus. Methods of restricting access to an access fitting or valve are also disclosed.

Typically refrigeration apparatus such as air conditioning units include refrigeration lines that have one or more access fittings or valves, such as fittings with valve cores (e.g., Shrader valves) used for charging or discharging refrigerant or other fluids from the system. While the access fittings or valves provide easy and convenient access points to the system for servicing and the like, they also enable unscrupulous or unauthorized access to or theft of the liquid or gases contained in the system, such as refrigerant (e.g., FREON®, R22, R410A, etc.), which is highly toxic and not environmentally friendly.

While various protective devices are commercially available for restricting access to such fittings and valves, it would be desirable to have such a device that can be operated with standard tooling that a technician or other user typically has on hand.

It is therefore an object of embodiments disclosed herein to provide a tamper-resistant locking device particularly suited for restricting access to an access fitting or valve in a refrigeration system.

It is another object of embodiments disclosed herein to provide a tamper-resistance locking device that may be operated with a standard tool.

These and other objects and features of the embodiments disclosed herein will become more fully apparent from the following description and the appended claims.

### SUMMARY

Problems of the prior art have been addressed by the embodiments disclosed herein, which relate to a locking device and seal for an access fitting or valve, and methods of locking and sealing an access fitting or valve to restrict access thereto. In certain embodiments, the locking device has an associated tool or key operable to attach or detach the locking device to an access fitting or valve, such as by a keyed connection.

In various embodiments, the locking device comprises an outer housing or sleeve having a first internal cavity, the outer housing having an upper surface having an aperture; an inner housing configured to be received in the internal cavity of the outer-housing, the inner housing having a second internal cavity defined by side walls at least a portion of which having internal threads for threadably connecting to an access fitting or valve or the like having corresponding external threads, the inner housing further having a third internal cavity or recess or socket having a keyed shape configured to be received by a corresponding tool or key. In various embodiments, the inner housing is dimensioned to allow for its independent rotation inside the outer housing about a common or coaxial longitudinal axis, and thus the inner housing is spaced from the inner side walls of the outer housing when in the assembled condition.

In some embodiments, the locking device comprises a sleeve having a top wall, a side wall extending from the top wall leading to a first open bottom end and having a through-hole therein, the top wall and side wall defining a first internal cavity; an inner housing having an inner housing top wall, and an inner housing side wall extending from the inner housing top wall leading to a second open bottom end and having a recess therein, the inner housing top wall and the inner housing side wall defining a second internal cavity, wherein the inner housing side wall has an interior surface that is threaded; and the inner housing being dimensioned to be positioned in the first internal cavity such that the through-hole and recess are aligned, the inner housing and the sleeve being independently rotatable.

In certain embodiments, a method of restricting access to an access fitting or valve is disclosed. The method includes coupling a locking device to an access fitting or valve, the locking device comprising an outer housing having a first internal cavity, the outer housing having an upper surface having an aperture; an inner housing configured to be received in the internal cavity of the outer housing, the inner housing having a second internal cavity defined by side wails at least a portion of which having internal threads for threadably connecting to an access fitting or valve or the like having corresponding external threads, the inner housing further having a third internal cavity or recess or socket having a shape configured to be received by a tool or key. The step of coupling the locking device to the access fitting or valve includes the use of a tool or key that engages with the inner housing to rotate the inner housing with respect to the access fitting or valve, and independently of the outer housing.

### BRIEF DESCRIPTION OF THE DRAWINGS

FIG. 1 is a top view of an outer housing or sleeve in accordance with certain embodiments;

FIG. 2 is a cross-sectional view of the outer housing or sleeve of FIG. 1 taken along line 2-2 in accordance with certain embodiments;

FIG. 3 is a bottom view of an inner housing in accordance with certain embodiments;

FIG. 4 is a cross-sectional view of the inner housing of FIG. 3 taken along line 4-4 in accordance with certain embodiments;

FIG. 5 is a top view of the inner housing in accordance with certain embodiments;

FIG. 6 is an exploded view of the locking device in accordance with certain embodiments;

FIG. 7 is a cross-sectional view of a locking device in an assembled condition in accordance with certain embodiments;

FIG. 8 is an exploded view showing the locking device and key tool as it approaches a threaded access fitting for attachment in accordance with certain embodiments;

FIG. 9 is a view, partly in cross-section, showing the locking device attached to a threaded access fitting or valve in accordance with certain embodiments;

FIG. 10 is an exploded view, partially in cross-section, of a first alternative embodiment of a locking device, key tool and access fitting or valve in accordance with certain embodiments;

FIG. 11 is an exploded view, partially in cross-section, of the embodiment of FIG. 10 with the inner housing contained in the outer housing in accordance with certain embodiments;

FIG. 12 is a cross-sectional view of the locking device of FIG. 11 shown being attached to a threaded access fitting or valve in accordance with certain embodiments;

FIG. 13 is an exploded view, partially in cross-section, of a locking device, key tool and access fitting or valve in accordance with certain embodiments;

FIG. 13A is a top view of a locking device of FIG. 13;

FIG. 14 is an exploded view, partially in cross-section, of a locking device, key tool and access fitting or valve in accordance with certain embodiments;

FIG. 14A is a top view of a locking device of FIG. 14;

FIG. 15 is an exploded view, partially in cross-section, of a locking device and access fitting or valve in accordance with certain embodiments;

FIG. 15A is a top view of the locking device of FIG. 15;

FIG. 16 is an exploded view, partially in cross-section, of a locking device, key tool and access fitting or valve in accordance with certain embodiments; and

FIG. 16A is a top view of the locking device of FIG. 16.

### DETAILED DESCRIPTION

A more complete understanding of the components, processes and devices disclosed herein can be obtained by reference to the accompanying drawings. The figures are merely schematic representations based on convenience and the ease of demonstrating the present disclosure, and are, therefore, not intended to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise(s),” “include(s),” “having,” “has,” “can,” “contain (s),” and variants thereof, as used herein, are intended to be open-ended transitional phrases, terms, or words that do not preclude the possibility of additional components.

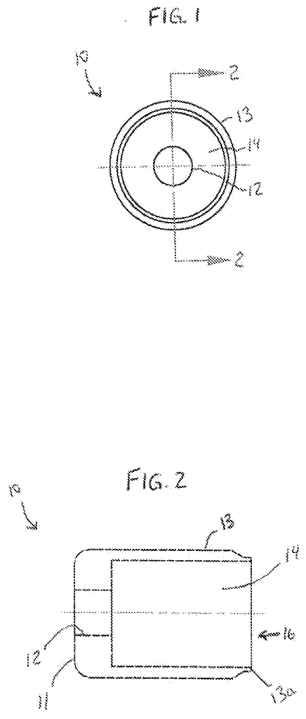

Turning now to FIGS. 1 and 2 and 6, there is shown an outer housing or sleeve 10 in accordance with certain embodiments. The sleeve 10 includes a top wall 11 having a through-hole 12, preferably centrally located in the top wall 11. Preferably the top wall 11 is flat or planar. Extending from the top wall 11 is a side wall 13 leading to an open bottom end 16. The top wall 11 and side wall 13 define an internal cavity 14 configured to receive an inner housing. In some embodiments, the free end 13a of the side wall 13 has a smaller thickness than the remainder of the side wall 13, facilitating bending of the free end so as to effectively slightly reduce the diameter of the open bottom end 16, to thereby contain the inner housing within the cavity. In certain embodiments, the sleeve 10 is a cylindrical structure.

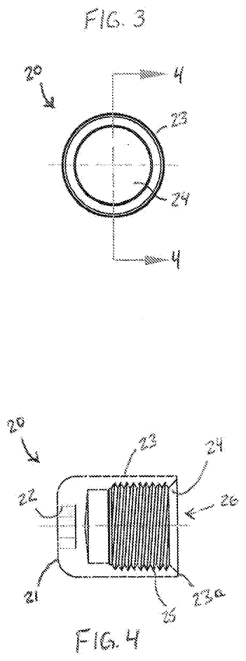

FIGS. 3-6 illustrate an embodiment of the inner housing 20. In the embodiment shown, the inner housing 20 has a top wall 21 that is preferably flat or planar. The top wall 21 includes a socket or recess 22 that has a polygonal cross-section, such as hexagonal. The recess 22 is configured to cooperate with a key or tool, such as by receiving and being engaged by the male end of a key or tool (e.g., accessed via through-hole 12 in the outer housing or sleeve 10). Applying torque to the tool once the tool is received by the recess 22 enables actuation of the inner housing 20, such as relative rotation of the inner housing with respect to the sleeve 10 when in the assembled condition. In various embodiments, the inner housing 20 is rotatably about a longitudinal axis bisecting the recess 22.

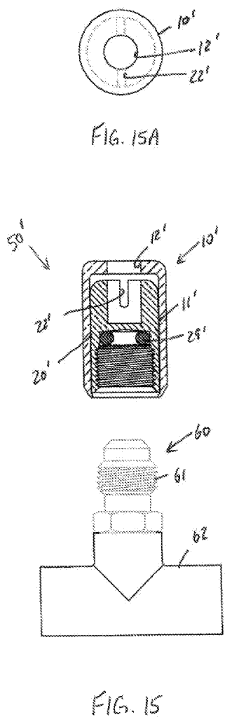

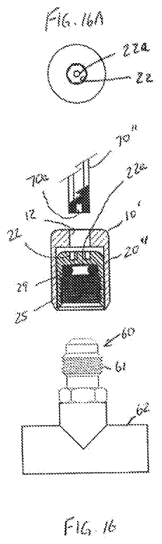

The recess 22 should be of sufficient depth so that the key can be inserted into the recess 22 and the inner housing 20 actuated without the key falling out of the recess 22. In various embodiments, a sufficient depth is about 3/32″. In certain embodiments, the recess 22 may have a polygonal cross-section. In one embodiment, the recess has a hexagonal cross-section configured to cooperate with a standard hex key such as an ALLEN® wrench. In another embodiment, as shown in FIGS. 13 and 13A, the recess 22 may have a star cross-section, such as a 6-point star configured to receive a standard star key such as a TORX wrench. A 12-point star socket also may be suitable. In a still further embodiment, as shown in FIGS. 14 and 14A, the recess 22 may have a square cross-section, and the tool used to actuate the inner housing 20 is a tooling having a free end with a square cross-section, such as a Robertson or SCRULOX® screw drive. In yet a further embodiment, the recess 22 may have a slotted configuration as shown in FIGS. 15 and 15A, and the tool used to actuate the inner housing 20′ is a blade-type or slotted screwdriver or the like.

Side wall 23 extends downwardly from the top wall 21 leading to a bottom opening 26 and terminating in free end 23a that leads to internal cavity 24. In various embodiments, the internal cavity has threads 25 configured to receive corresponding external threads of an access fitting or valve or other device which is received in cavity 24. Preferably the threads 25 are formed in the interior surface of the side wall 23. A sealing member 29 such as an O-ring or flat rubber washer or disk may be positioned in the internal cavity 26 in a region above the internal threads 25, as seen in FIG. 7, just beyond where the access fitting or valve sits in the cavity 26 when the locking device 50 is attached to the access fitting or valve.

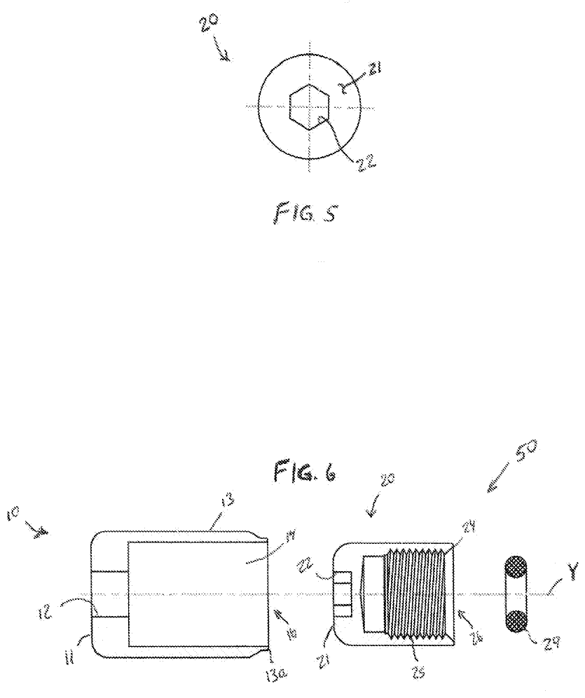

In certain embodiments, the outer dimensions of the inner housing 20 are such that relative rotation of the inner housing with respect to the sleeve 10, when the inner housing 20 is contained in the sleeve 10, may occur. The relative rotation may be about longitudinal axis “Y” shown in FIG. 6. Accordingly, in some embodiments the inner housing 20 has an outer diameter slightly smaller than the inner diameter of the cavity 16 of the sleeve 10. In embodiments where the sleeve 10 and the inner housing 20 are cylindrical, there is an annular gap between the inner housing 20 and the sleeve 10 when in the assembled condition.

In some embodiments, the outer sleeve 10 may have no top wall; e.g., it may be shaped as a cylinder, whereby the top surface of the locking device 50 is the top wall 21 of the inner housing 20.

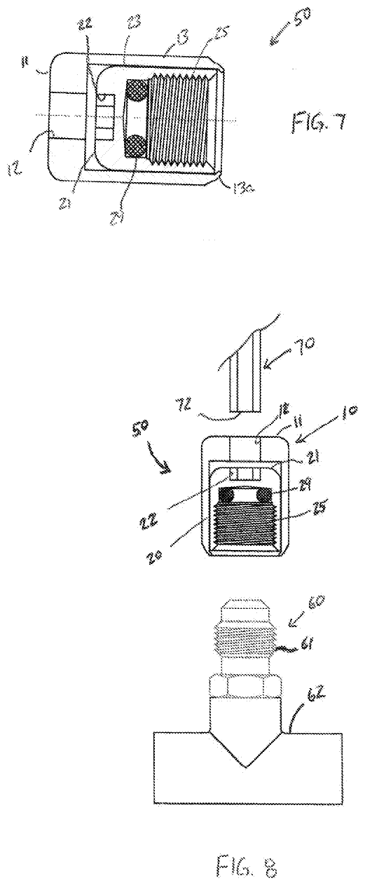

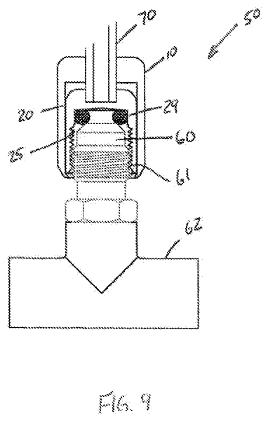

FIG. 8 illustrates a locking device 50 about to be attached to (or just having been detached from) an access fitting or valve 60. In the embodiment shown, the access fitting or valve 60 is a standard Shrader valve having external threads 61, and is coupled to a conduit 62 which may contain, or is configured to contain, a refrigerant, for example. The external threads 61 of the access fitting or valve 60 are configured to threadingly engage with the internal threads 25 in the locking device 50. Since the sleeve 10 is rotatable about a longitudinal axis independently of the inner housing 20, rotation of the sleeve 10 does not result in a corresponding rotation of the inner housing 20. As a result, the locking device 50 cannot be attached or detached from the valve 60 simply by rotating the sleeve 10.

Once the locking device 50 is brought into contact with the valve 60, a key 70 may be used to actuate the inner housing 20. Specifically, the key 70 has a free end 72 having a cross-section configured to mate and engage with the recess 22, such as a hexagonal cross-section or a 6-point star cross-section. Once engaged, the application of torque to the key 70 results a rotation of the inner housing 20 with respect to the sleeve 10, about a longitudinal axis passing through the center of through-hole 12 and recess 22, threading the inner housing 20 onto the access fitting or valve 60. The key 70 may be removed from the locking device 50, and access to the access fitting or valve 60 is now restricted, as rotation of the sleeve 10 does not cause rotation of the inner housing 20 and thus does not unthread the locking device 50 from the access fitting or valve 60.

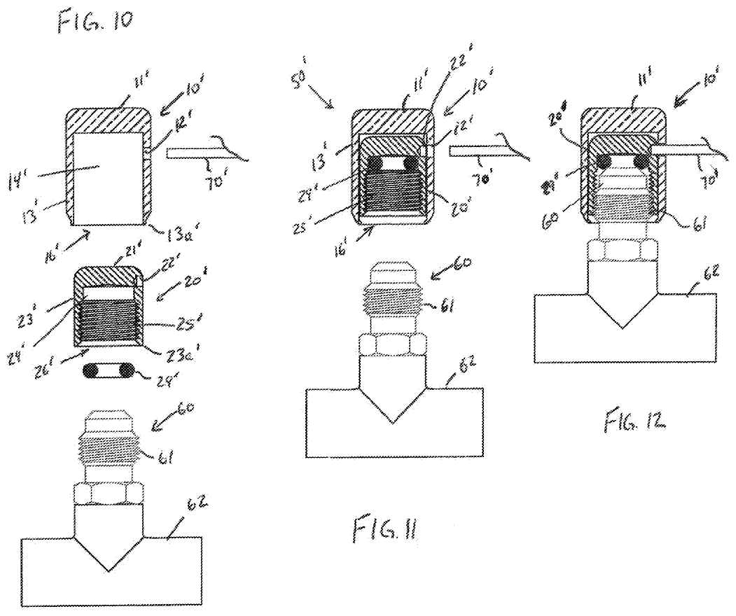

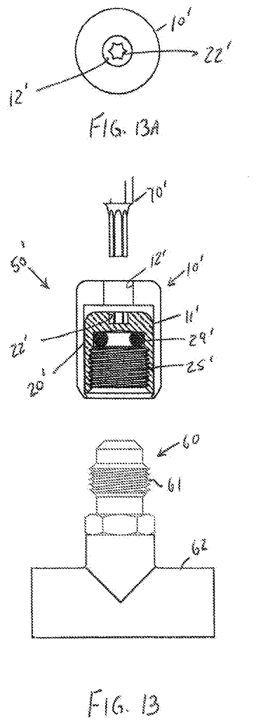

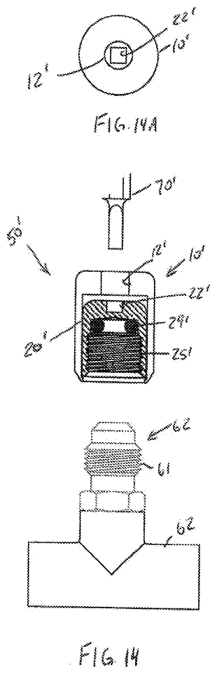

Turning now to FIG. 10, there is shown an outer housing or sleeve 10′ in accordance with certain embodiments. The sleeve 10′ includes a top wall 11′ which is preferably flat or planar. Extending from the top wall 11′ is a side wall 13′ leading to an open bottom end 16′. The top wall 11′ and side wall 13′ define an internal cavity 14′ configured to receive an inner housing. In some embodiments, the free end 13a′ of the side wall 13′ has a smaller thickness than the remainder of the side wall 13′, facilitating bending of the free end so as to effectively slightly reduce the diameter of the open bottom end 16′, to thereby contain the inner housing within the cavity. The side wall 13′ has a radial through-hole 12′ as shown. In certain embodiments, the sleeve 10′ is a cylindrical structure.

Also shown in FIG. 10 is an embodiment of the inner housing 20′. In the embodiment shown, the inner housing 20′ has a top wall 21′ that is preferably flat or planar. Side wall 23′ extends downwardly from the top wall 21′ leading to a bottom opening 26′ and terminating in free end 23a′ that leads to internal cavity 24′. In various embodiments, the internal cavity has threads 25′ configured to receive corresponding external threads of an access fitting or valve or other device which is received in cavity 24′. Preferably the threads 25′ are formed in the interior surface of the side wall 23′. A sealing member 29′ such as an O-ring or flat seal such as a rubber washer or disk may be positioned in the internal cavity 24′ in a region above the internal threads 25′, as seen in FIG. 11, just beyond where the access fitting or valve sits in the cavity 24′ when the locking device 50′ is attached to the access fitting or valve.

The side wall 13′ of the outer housing or sleeve 10′ has a through-hole 12′ extending radially inwardly. The through-hole 12′ is positioned in the side wall 13′ of the outer housing 10′ such that it aligns with a corresponding radial recess or socket 22′ in the side wall 23′ of the inner housing 20′ when the inner housing 20′ is contained in the internal cavity 14′ of the outer housing or sleeve 10′ when in the assembled condition as seen in FIG. 11. In certain embodiments, the recess 22′ may have a polygonal cross-section, such as a hexagonal cross-section configured to receive a standard hex key such as an ALLEN® wrench. In another embodiment, the recess 22′ may have a star cross-section, such as a 6-point star configured to receive a standard star key such as a TORX wrench. A 12-point star socket also may be suitable. In a still further embodiment, the recess 22′ may have a square cross-section, and the tool used to actuate the inner housing 20′ is a tooling having a free end with a square cross-section, such as a Robertson or SCRULOX® screw drive. (See FIG. 15 discussed below.)

In yet a further embodiment, both the outer housing and the inner housing may have coaxial through-holes, and a pin or the like (e.g., a 1/16 in diameter pin) may be inserted through the through-holes to lock the inner housing and outer housing together. Thus, rotation of the outer housing 10′ about a longitudinal axis passing through the longitudinal centerline of the locking device 50 causes rotation of the inner housing 20′ about that axis, thereby attaching or detaching the locking device 50′ from the valve 60. The shaft of the tool 70′ may be used to facilitate rotation of the locking device 10′.

FIG. 15 shows a further embodiment, the recess 22′ may have a slotted configuration and the tool used to actuate the inner housing 20′ is a commercially available CATV cable locking and unlocking terminator tool, where retractable radial tabs are positioned near the distal free end of the tool and once the tool is inserted into the through-hole 12′ and recess 22′, the retracted tabs are extended and are received by the slot, allowing the tool to rotate the inner housing 20′ to thread or unthread it from an access fitting or valve.

FIG. 16 shows a further embodiment of a locking cap. In this embodiment, the outer housing 10 is identical to the embodiment shown in FIG. 6. The inner housing 20″ is similar to the embodiment of FIG. 6 or FIG. 13, except that the hex-shaped or star recess 22 includes a central axial pin 22a. The corresponding tool 70″ is also similar to the tool 70 of FIG. 8 or FIG. 13, except that it includes a central recess 70a configured to receive the pin 22a. The pin 22a prevents proper insertion of a hex wrench or ALLEN or TORX key, adding a further layer of tamper resistance to the device.

What is claimed is:

1. A locking device for use with an access fitting, the locking device comprising:
a sleeve having a top wall with a through-hole therein, a side wall extending from said top wall leading to a first open bottom end, the top wall and side wall defining a first internal cavity;
an inner housing having an inner housing top wall having a recess therein that is polygonal in cross-section, and an inner housing side wall extending from said inner housing top wall leading to a second open bottom end, said inner housing top wall and said inner housing side wall defining a second internal cavity, wherein said inner housing side wall has an interior surface that is threaded;
said inner housing being dimensioned to be positioned in said first internal cavity and independently rotatable therein with respect to said sleeve;
and wherein said recess is accessible through said through-hole of said sleeve to rotate said inner housing with respect to said sleeve.

2. The locking device of claim 1, wherein said recess is hexagonal in cross-section.

3. The locking device of claim 2, wherein said recess is configured to receive a hex key.

4. The locking device of claim 2, wherein said recess includes a central pin.

5. The locking device of claim 2, wherein said recess is star-shaped in cross-section.

6. The locking device of claim 5, wherein said recess is a 6-point star or a 12-point star.

7. The locking device of claim 2, wherein said recess is square-shaped in cross-section.

8. The locking device of claim 7, wherein said recess is configured to receive a square tool.

9. The locking device of claim 2, wherein said recess is a slot.

10. A method of restricting access to an access fitting, wherein said locking device comprises:
a sleeve having a top wall with a through-hole therein, a side wall extending from said top wall leading to a first open bottom end, the top wall and side wall defining a first internal cavity;
an inner housing having an inner housing top wall having a recess therein that is polygonal in cross-section, and an inner housing side wall extending from said inner housing top wall leading to a second open bottom end, said inner housing top wall and said inner housing side wall defining a second internal cavity, wherein said inner housing side wall has an interior surface that is threaded;
said inner housing being dimensioned to be positioned in said first internal cavity and independently rotatable therein with respect to said sleeve;
said method comprising coupling said locking device to said access fitting by accessing said recess through said through-hole of said sleeve with a key to rotate said inner housing with respect to said sleeve and thread said inner housing onto said access fitting.

11. The method of claim 10, wherein said recess is hexagonal in cross-section, and said key is a hex key.

12. The method of claim 10, wherein said recess is star-shaped in cross-section, and said key is a star wrench.

13. The method of claim 10, wherein said recess is square-shaped in cross-section, and said key is a square tool.

14. A locking device for use with an access fitting, the locking device comprising:
a sleeve having a top wall, a side wall extending from said top wall leading to a first open bottom end and having a through-hole therein, the top wall and side wall defining a first internal cavity;
an inner housing having an inner housing top wall, and an inner housing side wall extending from said inner housing top wall leading to a second open bottom end and having a recess therein, said inner housing top wall and said inner housing side wall defining a second internal cavity, wherein said inner housing side wall has an interior surface that is threaded; and
said inner housing being dimensioned to be positioned in said first internal cavity such that said through-hole and recess are aligned, said inner housing and said sleeve being independently rotatable.

15. The locking device of claim 14, wherein said recess has a polygonal cross-section.
